(19) United States
(12) Patent Application Publication
(10) Pub. No.: US 2026/0217326 A1
(43) Pub. Date: Jul. 30, 2026

(54) MECHANICAL DOOR ADJUSTMENT

(71) Applicant: Tesla, Inc., Austin, TX (US)

(72) Inventors: Kriya Wong, San Francisco, CA (US); Shakeel Theodore, Fremont, CA (US); Eric Jonathan Rifel, Austin, TX (US); Viorel Bogdan Grosu, Alameda, CA (US); Daniel Lopez Espinosa, Austin, TX (US); Alessandro Panighetti, Austin, TX (US); Dallin Patrick Woodbrey, Austin, TX (US)

(21) Appl. No.: 19/138,743

(22) PCT Filed: Dec. 13, 2023
(86) PCT No.: PCT/US2023/083915

§ 371 Date: Jun. 13, 2025

Related U.S. Application Data
(60) Provisional application No. 63/432,604, filed on Dec. 14, 2022.

(51) Int. Cl. B62D 65/02; B62D 65/14

(52) U.S. Cl. CPC B62D 65/026; B62D 65/14

(57) ABSTRACT

An alignment system may include a rail connected to the first panel and extending through the second panel. An alignment system may include a first clamp mechanism fixed to the second panel, the first clamp mechanism being configured to slide along the rail between a plurality of positions so as to change a distance between the first panel and the second panel, the first clamp mechanism being movable from an unlocked position to a locked position so as to fix the first clamp mechanism to the rail in one of the plurality of positions.

### TECHNICAL FIELD

This application relates to mechanical door adjustment, and more particularly relates to systems and methods for adjusting a position of a body panel of a vehicle.

### BACKGROUND

In the context of vehicles, body panels and alignment issues are well known. Thus, when manufacturing a vehicle there may exist certain adjustments to better align various parts. However, these methods are often costly and have limited success.

### SUMMARY

In some aspects, the techniques described herein relate to an alignment mechanism for adjusting a position of a first panel relative to a second panel, the alignment mechanism including: a rail connected to the first panel and extending through the second panel; and a first clamp mechanism fixed to the second panel, the first clamp mechanism being configured to slide along the rail between a plurality of positions so as to change a distance between the first panel and the second panel, the first clamp mechanism being movable from an unlocked position to a locked position so as to fix the first clamp mechanism to the rail in one of the plurality of positions.

In some aspects, the techniques described herein relate to an alignment mechanism, further including a spring configured to bias the second panel relative to the first panel.

In some aspects, the techniques described herein relate to an alignment mechanism, wherein the first panel and the second panel are door panels.

In some aspects, the techniques described herein relate to an alignment mechanism, wherein the rail has a cylindrical shape.

In some aspects, the techniques described herein relate to an alignment mechanism, further including a second clamp configured to fix a position of rail relative to the first panel.

In some aspects, the techniques described herein relate to an alignment mechanism, wherein the rail is adjustable in a Y-axis direction; and the second panel is adjustable on the rail in an X-axis direction.

In some aspects, the techniques described herein relate to an alignment mechanism, wherein the second clamp fixes a Y-axis position of the rail and shifts an X-axis position of the rail.

In some aspects, the techniques described herein relate to an alignment mechanism, wherein the first clamping mechanism includes a cam.

In some aspects, the techniques described herein relate to an alignment mechanism for adjusting a position of a first panel relative to a second panel, the alignment mechanism including: a rail connected to the first panel and configured to extend through the second panel; a first clamping mechanism connected to the second panel and being configured to slide along the rail so as to change an X-axis distance between the first panel and the second panel, the first clamping mechanism being movable from an unlocked position to a locked position so as to fix the X-axis position of the first panel relative to the second panel; and a second clamping mechanism movable from an unlocked position to a locked position so as to fix a Y-axis position of the first panel relative to the second panel and shift the X-axis position of the first panel.

In some aspects, the techniques described herein relate to an alignment mechanism, further including a spring configured to bias the second panel relative to the first panel.

In some aspects, the techniques described herein relate to an alignment mechanism, wherein the rail has a cylindrical shape.

In some aspects, the techniques described herein relate to an alignment mechanism, wherein the second panel includes a body and a fastener, the fastener being configured to move in a Y direction relative to the body; wherein the second clamping mechanism includes a bolt configured to pass through the rail and engage with the fastener; and wherein when the second clamping mechanism is in the locked position, the bolt is tightened.

In some aspects, the techniques described herein relate to an alignment mechanism, wherein the fastener is a t-nut.

In some aspects, the techniques described herein relate to an alignment mechanism, wherein the first clamping mechanism includes a cam.

In some aspects, the techniques described herein relate to a method for adjusting a position of a first panel relative to a second panel, the method including: moving the first panel in an X-axis direction relative to the second panel; fixing an X-position of the first panel in a first X position relative to the second panel; moving the first panel in a Y-axis direction relative to the second panel; and fixing a Y-position of the first panel in a first Y position relative to the second panel, wherein fixing the Y-position also moves the first panel in the X-axis direction to a second X position.

In some aspects, the techniques described herein relate to a method, further including biasing the first panel in an X direction.

In some aspects, the techniques described herein relate to a method, further including aligning the first panel to a third panel.

In some aspects, the techniques described herein relate to a method, wherein moving the first panel in an X-axis direction includes sliding the first panel on a rail of the second panel.

In some aspects, the techniques described herein relate to a method, wherein fixing the X-position of the first panel in a first X position includes tightening a cam.

In some aspects, the techniques described herein relate to a method, wherein fixing the Y-position of the first panel in a first Y position includes tightening a screw.

In some aspects, the techniques described herein relate to a method, wherein fixing the Y-position causes the first panel to move 0.1-5.0 mm in the X-axis direction to a second X position.

### BRIEF DESCRIPTION OF THE DRAWINGS

The present inventions are described with reference to the accompanying drawings, in which like reference characters reference like elements, and wherein:

FIG. 1 is a representation of an interior of a vehicle.

FIG. 2A illustrates a view of a first embodiment of an alignment mechanism that is hidden behind a panel of the interior of the vehicle in FIG. 1.

FIG. 2B illustrates a view of the first embodiment of FIG. 2A in an alternative position.

FIG. 3A illustrates a view of a second embodiment of an alignment mechanism.

FIG. 3B illustrates a more detailed view of the second embodiment from FIG. 3A.

FIG. 3C is a cut-away view of the interior of the vehicle taken through the second embodiment.

FIG. 4A illustrates a view of an alignment mechanism for aligning along the Y-axis.

FIG. 4B illustrates a view of the alignment mechanism from FIG. 4A in an alternative position.

FIG. 5 is a flowchart which illustrates a method that employs the alignment mechanisms disclosed herein.

FIG. 6 illustrates a view of an embodiment of an alignment mechanism.

FIG. 7 illustrates a view of the alignment mechanism from FIG. 6.

### DETAILED DESCRIPTION

Generally described, one or more aspects of the present disclosure relate to a mechanical alignment and locking system. The alignment system disclosed herein has general applicability in many products and industries including vehicles, robots, manufacturing, aerospace, and industrial. For ease of description, the alignment system will be described in the context of vehicles. However, the application of the locking mechanism disclosed herein is not limited to vehicles and has applicability in many industries.

Traditional approaches to an alignment and locking mechanism have relied on methods such as ratcheting mechanisms and have involved significant labor. Traditional alignment mechanisms resulted in inadequate alignment of components, an unsecure hold, and incremental vs infinite adjustment. These shortcomings have resulted in increased time, cost, and issues during manufacturing and in use.

To address some of the deficiencies associated with a traditional alignment and locking systems, certain embodiments described herein provide an alignment and locking system that has infinite adjustment, spring biased alignment, and/or a one-step locking step during manufacturing.

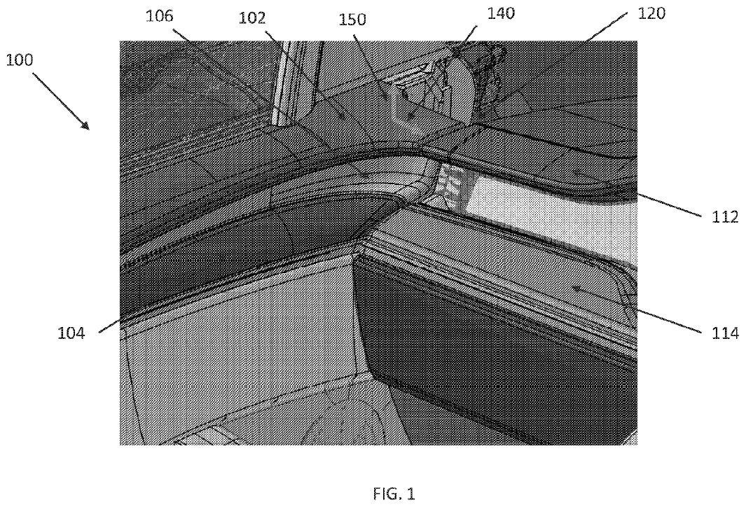

FIG. 1 is a representation of an interior of a vehicle 100 comprising a first door panel 102, a second door panel 104, a first dash panel 112, and a second dash panel 114. The first door panel 102, the second door panel 104 may be a full door panel, components of a door panel, or any interior vehicle component. The first dash panel 112, and the second dash panel 114 may be a full dash panel, components of a dash panel, or any interior vehicle component.

The present disclosure relates to the alignment of at least two interior vehicle components. In the present embodiment the components being aligned are the first door panel 102 and the first dash panel 112. The first door panel 102 and the first dash panel 112 meet at the first meeting point 120. At the first meeting point 120 the first door panel 102 and the first dash panel 112 are aligned in both an X axis, indicated by arrow 140, and Y-axis, indicated by arrow 150. The X-axis 140 would be substantially aligned with a left to right direction via a passenger's perspective. The Y-axis 150 would be substantially aligned with an up and down direction via a passenger's perspective.

A first embodiment of the alignment mechanism 200 allows the alignment and locking in a position of the first door panel 102. The first embodiment 200 is located behind the first door sub panel 106.

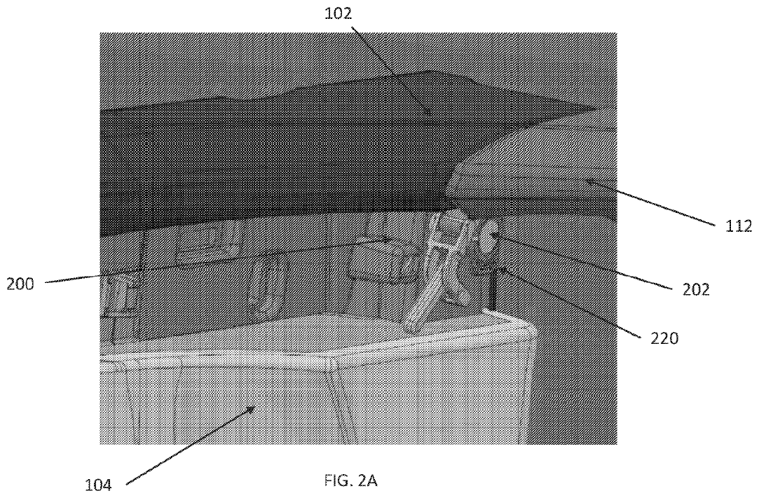

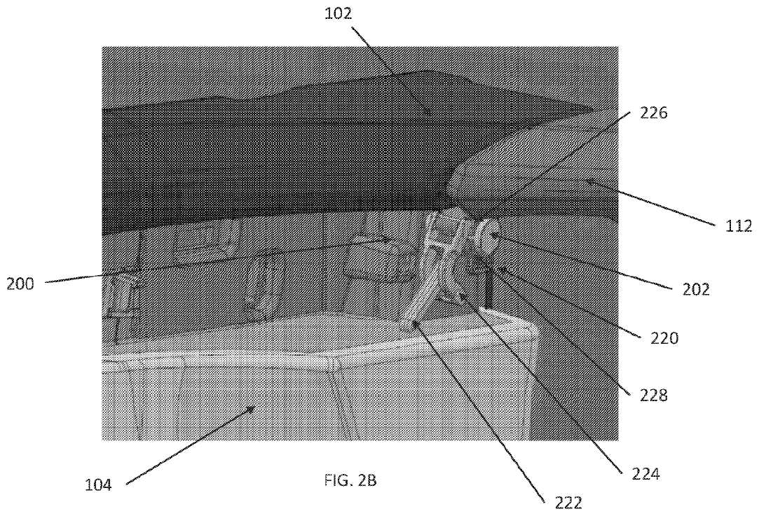

FIG. 2A illustrates a view of the first embodiment of the alignment mechanism 200 that is hidden behind the first door sub panel 106 of the interior of the vehicle in FIG. 1. The first embodiment of the alignment mechanism 200 comprises a horizontal rail 202 and a clamping mechanism 220. The horizontal rail 202 may be coupled to the second door panel 104. The position of the horizontal rail 202 may be fixed in relation to the second door panel 104. The horizontal rail 202 may also be a part of the second door panel 104 or connected to the second door panel 104 in any way, such as through an intermediary component. The horizontal rail 202 may be a cylinder as in the present embodiment or it may be an alternative shape such as a square tube, a rectangle tube, a beam, or any suitable shape permitting a sliding of the components in relation to each other. The clamping mechanism 220 may be coupled to the first door panel 102. The position of the clamping mechanism 220 may be fixed in relation to the first door panel 102. In the present embodiment, the clamping mechanism 220 comprises a locking lever 222, a locking arm 224, a first engagement interface 226, and a second engagement interface 228 (FIG. 2B). The first engagement interface 226 and the second engagement interface 228 may be connected to the first door panel 102, another interior door component, or the door itself. The first engagement interface 226 and the second engagement interface 228 may be the same part as the first door panel 102 or they may be different parts.

In certain embodiments, the clamping mechanism 220 is configured to clamp the horizontal rail 202. FIG. 2A shows the first door panel 102 in a first position and the clamping mechanism 220 in an unlocked state. In certain embodiments, the locking lever 222 and the locking arm 224 work in conjunction to apply a force to the first engagement interface 226 and/or the second engagement interface 228. The force may be applied to either the first engagement interface 226 or the second engagement interface 228 or both. When the force is applied to the first engagement interface 226 and the second engagement interface 228, the clamping mechanism 220 engages the horizontal rail 202 so as to lock a position of the first door panel 102. The position of the first door panel 102 is locked in terms of the X-axis direction. In the present embodiment, the first door panel 102 is locked in relation to the second door panel 104, which is locked to the vehicle door either directly or indirectly. The first embodiment of the alignment mechanism 200 can lock the first door panel 102 in relation to the other components on the door, the door itself, the door hinges, the vehicle, and/or the other components of the vehicle.

FIG. 2B shows the first door panel 102 in a second position and the clamping mechanism 220 in an unlocked state. The first position and the second position differ in the position of the first door panel 102 in terms of the X-axis. In the second position, the first door panel 102 is displaced to the left relative to the horizontal rail 202, and thus also displaced to the left relative to the second door panel 104.

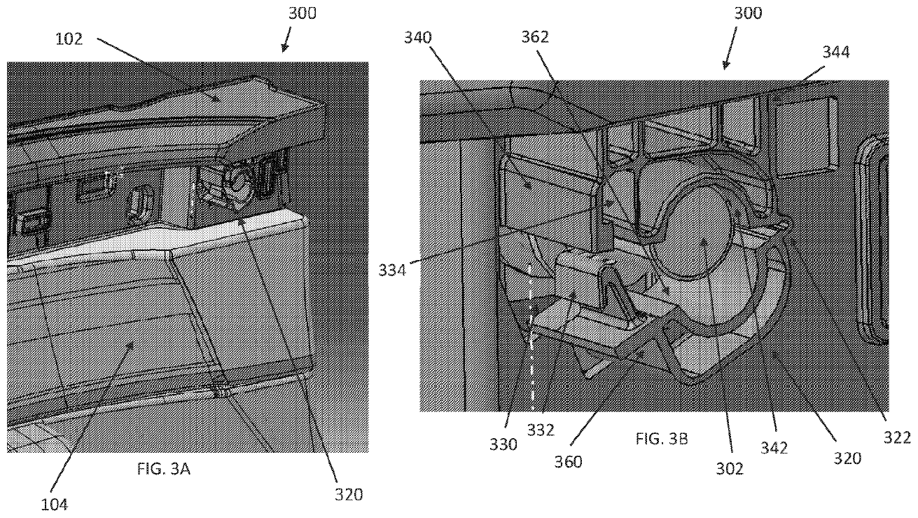

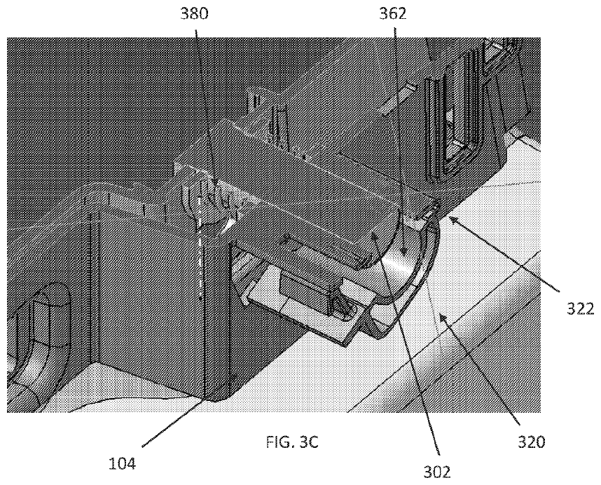

FIG. 3A shows a second embodiment of an alignment mechanism 300. The second embodiment of the alignment mechanism 300 comprises a horizontal rail 302 and a clamping mechanism 320. The horizontal rail 302 may be coupled to the second door panel 104. The horizontal rail 302 may also be a part of the second door panel 104 or connected to the second door panel 104 in any way, such as through an intermediary component. The horizontal rail 302 may further be connected directly to the vehicle door. The clamping mechanism 320 is connected to the first door panel 102. The clamping mechanism 320 may be a part of the first door panel 102, it may be connected to the first door panel 102 directly or indirectly.

FIG. 3B shows a more detailed view of the second embodiment 300 from FIG. 3A. In certain embodiments, the clamping mechanism 320 comprises an upper portion 340 and a lower portion 360. The upper portion 340 and the lower portion 360 may be connected via a hinge 322. The hinge 322 may be a bending hinge, a pivoting hinge, a single piece hinge, a living hinge, or a multi piece hinge. The hinge 322 allows the upper portion 340 and the lower portion 360 to come together in a pivoting movement so as to clamp the horizontal rail 302.

The upper portion 340 may comprise an upper horizontal rail interface portion 342. The upper horizontal rail interface portion 342 may be shaped to match the shape of the horizontal rail 302. In this case the upper horizontal interface portion 342 is shaped as a cylinder to receive a cylinder. The upper portion 340 may further comprise an upper connector portion 344. The upper connector portion 344 is configured to connect the clamping mechanism 320 to the first door panel 102.

The lower portion 360 may comprise a lower horizontal rail interface portion 362. The lower horizontal interface portion 362 may be shaped to match the shape of the horizontal rail 302. In this case the lower horizontal interface portion 362 is shaped as a cylinder to receive a cylinder.

The clamping mechanism 320 may further comprise a lock 330. The lock 330 can allow the lower portion 360 to engage the upper portion 340. The lock 330 may further be configured to create a compressive force on the horizontal rail 302 with the upper horizontal interface portion 342 and the lower horizontal interface portion 362. The lock 330 may comprise a clip 332. The clip 332 may be a part of the lower portion 360 as shown in the present embodiment or it may be a part of the upper portion 340. The lock 330 may comprise a clip receiving feature 334. The clip receiving feature 334 may be a part of the upper portion 340 as shown in the present embodiment or it may be a part of the lower portion 360.

FIG. 3C is a cut-away view of the interior of the vehicle taken through the second embodiment of the alignment mechanism 300. The second embodiment of the alignment mechanism 300 may further comprises a spring 380. In certain embodiments, the spring 380 can act to bias the first door panel 102 away from the door, inbound, and towards the first dash panel 112 in the X-axis direction. The force of the spring 380 allows the first door panel 102 to move towards the first dash panel 112. When the vehicle door is close, and the second embodiment of the alignment mechanism 300 is in an unlocked state, the first door panel 102 will move towards the first dash panel 112 until the two make contact. The contact need not be direct, as a spacer may be used during assembly. At this time the first door panel 102 will be properly aligned with the first dash panel 112. Proper alignment may be a direct flush connection between the first door panel 102 and the first dash panel 112. After proper alignment is reached, the clamping mechanism 320 may be locked, so as to lock the second embodiment of the alignment mechanism 300, and thus lock the position of the first door panel 102.

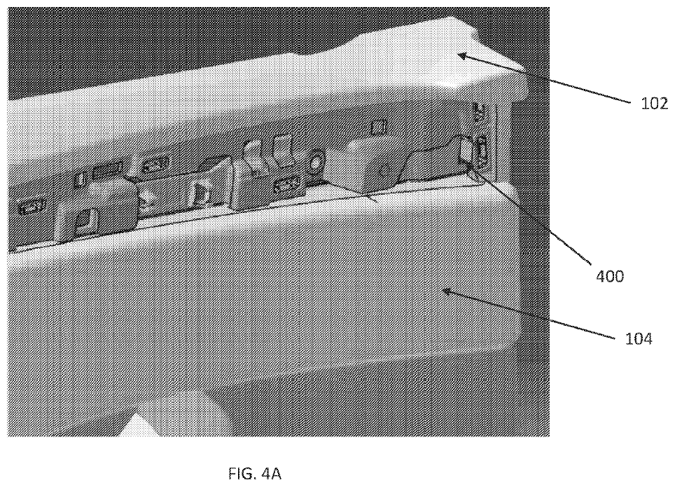

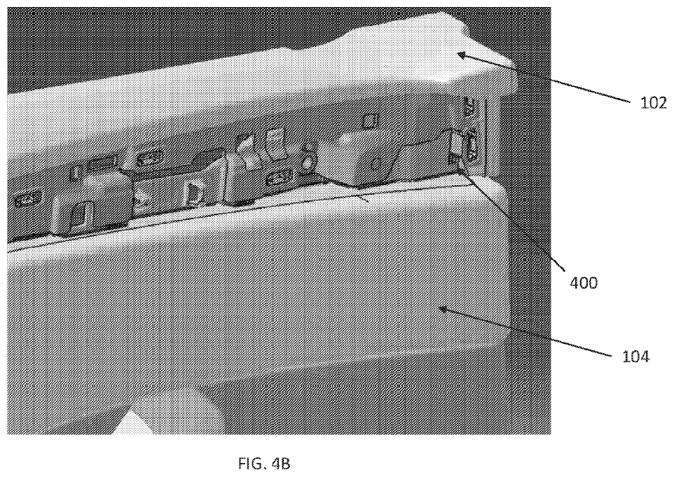

FIG. 4A and FIG. 4B illustrate the first door panel 102 moving in the Y-axis direction relative to the second door panel 104. The alignment mechanisms 200, 300 disclosed herein may further comprise features and components to align the first door panel 102 to the first dash panel 112 in terms of the Y-axis. In the illustrated embodiment, the first door panel 102 is able to move relative to the second door panel 104 due to at least one oversized slot 400. The oversized slots 400 allow for the movement of the first door panel 102 in relation to the second door panel 104. FIG. 4B shows the first door panel 102 in an upper or higher position relative to its position in FIG. 4A.

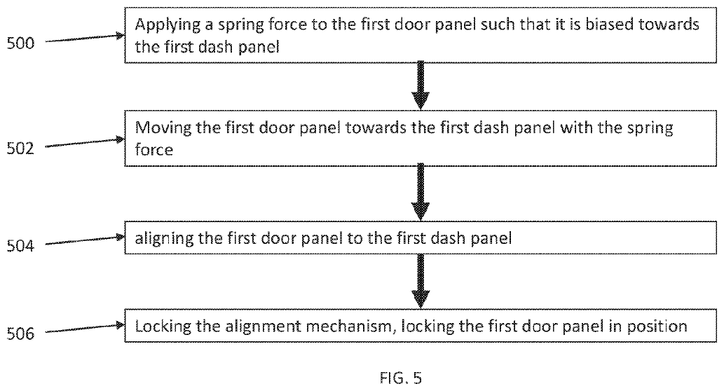

FIG. 5 illustrates a method that employs the alignment mechanisms 200, 300 disclosed herein. Prior to step 500 the method may comprise a number of steps such as installing other components, aligning other components, locking other components in alignments, or closing the vehicle door. The method may comprise aligning and locking the first door panel 102 in the Y-axis as shown in FIGS. 4A and 4B. Step 500 comprises applying a spring force to the first door panel 102 such that it is biased towards the first dash panel 112. The spring 380 previously disclosed may apply the spring force against the first door panel 102. Step 502 comprises moving the first door panel 102 towards the first dash panel 112 with the spring force. The first door panel 102 may move towards the first dash panel 112 due to the spring force. Step 504 comprises aligning the first door panel 102 to the first dash panel 112. Aligning the first door panel 102 to the first dash panel 112 may comprise contacting the first door panel 102 to the first dash panel 112. Once alignment is created, the method moves to step 506. At step 506, the alignment mechanism 200, 300 is locked by locking the first door panel 102 in position. At least a portion of the alignment mechanism 200, 300 is coupled to the first door panel 102. Thus, when locking the alignment mechanism 200, 300, one is also inherently locking the first door panel 102 in position. It should be noted this may only be in relation to its X-axis position.

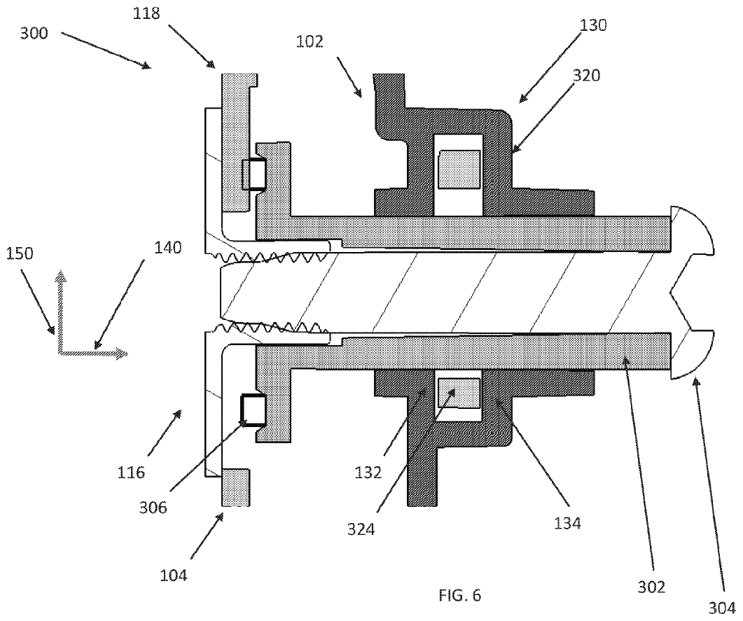

FIG. 6 illustrates an alternative embodiment of the alignment mechanism 300. The alignment mechanism 300 comprises a horizontal rail 302 and a clamping mechanism 320, this may be referred to as a first clamping mechanism 320. The horizontal rail 302 may also be referred to as a sleeve. The clamping mechanism 320 can comprise the cam 324. The horizontal rail 302 can be coupled to the second door panel 104 by the door bolt 304. The horizontal rail 302 may further be connected directly to the vehicle door via the door bolt 304. The clamping mechanism 320 is connected to the first door panel 102. The clamping mechanism 320 can further be secured to the first door panel 102 by a cam pocket 130. The cam pocket 130 can include a first wall 132 and a second wall 134, that together confine the cam 324 in the X axis direction, as indicated by arrow 140. The second door panel 104 can comprise a T-nut 116. The t-nut 116 can slid up and down (in the y-axis as indicated by arrow 150) in relation to a body 118 of the second door panel 104.

The door bolt 304 passes through the horizontal rail 302 and secures itself into the t-nut 116. As the door bolt 304 tightens, the second door panel 104 is compresses against the horizontal rail 302. The horizontal rail 302 or the second door panel 104 may further comprise compression tabs 306. The compression tabs 306 may be connected to or be a part of the horizontal rail 302. When the door bolt 304 is tightened, the distance between the head of the door bolt 304 and the t-nut 116 is lessened, resulting in the compression of the second door panel 104, the compression tabs 306, and the door bolt 304, between the t-nut 116 and the head of the door bolt 304.

The first door panel 102 can be secured to the horizontal rail 302 via the cam 324. After the first door panel 102 is secured to the horizontal rail 302, locking the X-axis position of the first door panel 102 relative to the second door panel 104, the door bolt 304 may be secure locking in the Y-axis position. As the door bolt 304 tightens it compresses and the compression tabs 306. In compressing the compression tabs 306, the X-axis position of the first door panel 102 is shifted a slight distance. In some embodiments, this shift may be between 1-5 mm. This shift of the X-axis position of the first door panel 102 in relation to second door panel 104 allows for a small gap to be formed between the first door panel 102 and the first dash panel 112. A small gap of 1-5 mm between panels (i.e., first door panel 102 and first dash panel 112) is beneficial, as it reduces friction and wear on components. This compression of the compression tabs 306 results in a repeatable shift of the first door panel 102, relative to the second door panel 104, and as such relative to the first dash panel 112 when the door is closed.

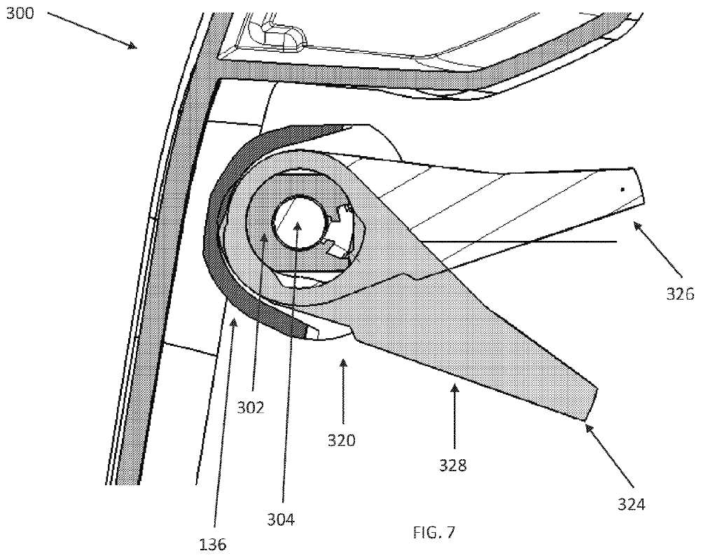

FIG. 7 illustrates an alternative embodiment of the alignment mechanism 300. The alignment mechanism 300 comprises a horizontal rail 302 and a clamping mechanism 320. The clamping mechanism 320 can comprise a cam 324. FIG. 7 shows the cam 324 in a first position 326 and a second position 328. When the cam 324 is in a first position 326, the cam 324 is able to slide along the horizontal rail 302, allowing for X-axis adjustment of the first door panel 102 in relation to the second door panel 104. When the cam 324 is in the second position 328, the cam interacts with a third wall 136 of the first door panel 102. In the second position 328 (when the cam 324 is rotated down), the cam 324 compresses against the third wall 136, resulting in a compression of the cam 324 against the horizontal rail 302. The compression of the cam 324 against the horizontal rail 302 locks the X-axis position of the first door panel 102 relative to the horizontal rail 302, and in turn relative to the second door panel 104. When the door bolt 304 is tightened, the horizontal rail 302 can shift 1-5 mm in the x direction, and as such the first door panel 102 shifts 1-5 mm in the X-axis direction relative to the second door panel 104. This can leave a 1-5 mm gap between the first door panel 102 and another component of the vehicle, such as the first dash panel 112.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. An alignment mechanism for adjusting a position of a first panel relative to a second panel, the alignment mechanism comprising:
a rail connected to the first panel and extending through the second panel; and
a first clamp mechanism fixed to the second panel, the first clamp mechanism being configured to slide along the rail between a plurality of positions so as to change a distance between the first panel and the second panel, the first clamp mechanism being movable from an unlocked position to a locked position so as to fix the first clamp mechanism to the rail in one of the plurality of positions.

2. The alignment mechanism of claim 1, further comprising a spring configured to bias the second panel relative to the first panel.

3. The alignment mechanism of claim 1, wherein the first panel and the second panel are door panels.

4. The alignment mechanism of claim 1, wherein the rail has a cylindrical shape.

5. The alignment mechanism of claim 1, further comprising a second clamp configured to fix a position of rail relative to the first panel.

6. The alignment mechanism of claim 5, wherein the rail is adjustable in a Y-axis direction; and
the second panel is adjustable on the rail in an X-axis direction.

7. The alignment mechanism of claim 6, wherein the second clamp fixes a Y-axis position of the rail and shifts an X-axis position of the rail.

8. The alignment mechanism of claim 1, wherein the first clamping mechanism comprises a cam.

9. An alignment mechanism for adjusting a position of a first panel relative to a second panel, the alignment mechanism comprising:
a rail connected to the first panel and configured to extend through the second panel;
a first clamping mechanism connected to the second panel and being configured to slide along the rail so as to change an X-axis distance between the first panel and the second panel, the first clamping mechanism being movable from an unlocked position to a locked position so as to fix the X-axis position of the first panel relative to the second panel; and
a second clamping mechanism movable from an unlocked position to a locked position so as to fix a Y-axis position of the first panel relative to the second panel and shift the X-axis position of the first panel.

10. The alignment mechanism of claim 9, further comprising a spring configured to bias the second panel relative to the first panel.

11. The alignment mechanism of claim 9, wherein the rail has a cylindrical shape.

12. The alignment mechanism of claim 9, wherein the second panel comprises a body and a fastener, the fastener being configured to move in a Y direction relative to the body;
wherein the second clamping mechanism comprises a bolt configured to pass through the rail and engage with the fastener; and
wherein when the second clamping mechanism is in the locked position, the bolt is tightened.

13. The alignment mechanism of claim 12, wherein the fastener is a t-nut.

14. The alignment mechanism of claim 9, wherein the first clamping mechanism comprises a cam.

15. A method for adjusting a position of a first panel relative to a second panel, the method comprising:
moving the first panel in an X-axis direction relative to the second panel;
fixing an X-position of the first panel in a first X position relative to the second panel;
moving the first panel in a Y-axis direction relative to the second panel; and
fixing a Y-position of the first panel in a first Y position relative to the second panel,
wherein fixing the Y-position also moves the first panel in the X-axis direction to a second X position.

16. The method of claim 15, further comprising biasing the first panel in an X direction.

17. The method of claim 15, further comprising aligning the first panel to a third panel.

18. The method of claim 15, wherein moving the first panel in an X-axis direction comprises sliding the first panel on a rail of the second panel.

19. The method of claim 15, wherein fixing the X-position of the first panel in a first X position comprises tightening a cam.

20. The method of claim 15, wherein fixing the Y-position of the first panel in a first Y position comprises tightening a screw.

21. The method of claim 15, wherein fixing the Y-position causes the first panel to move 0.1-5.0 mm in the X-axis direction to a second X position.
